(19) United States
(12) Patent Application Publication
(10) Pub. No.: US 2004/0025711 A1
(43) Pub. Date: Feb. 12, 2004

(54) Roasting bag

(76) Inventor: Shelly Leann Cook, Dallas, TX (US)

Correspondence Address: Grant Rodolph, 10204 shadow way, Dallas, TX, 75243, US

(21) Appl. No.: 10/215,734

(22) Filed: Aug. 10, 2002

(51) Int. Cl. A23P 1/00

(52) U.S. Cl. 99/426

(57) ABSTRACT

The present invention is an improved roasting bag for food items. The improved roasting bag contains a valve to drain fluids out of the bag. The improved roasting bag also contains a pair of handles which are used to orient and position the improved roasting bag while the fluids are draining out of the improved roasting bag. The invention also contains a vent slit to help facilitate the draining process. A number of different valve configurations are disclosed to use in conjunction with the present invention.

### FIELD OF THE INVENTION

The present invention relates generally to cooking aids and specifically to an improved roasting bag for cooking food.

### BACKGROUND OF THE INVENTION

In roasting food products, such as roast beef, ham, pork, turkey, chicken and fish, the food product is normally placed in a pan and then heated in an oven. Usually, such food products must be basted with a suitable basting fluid such that the food does not dry out during the cooking process. In this case, a roasting bag is usually used to enclose the food product and the basting fluid. Alternatively, the chef may want to capture the fluids produced by the food product during the cooking process. This is usually done so that the produced fluid can be used in a sauce or gravy. Here too, a roasting bag is typically used to capture the produced fluids from the food product.

A need still exists however for a suitable manner in which the chef may remove the captured fluids from the roasting bag. Conventional roasting bags are sealed with a twist tie or similar mechanism and do not lend themselves to clean, safe, and efficient removal of the hot air and fluids from the roasting bag. The roasting bag is normally very hot from the cooking process in the oven and contains air which has expanded during the heating process and is pressurized within the roasting bag. A need exists for a convenient method to release the hot air from the roasting bag without releasing the fluids contained therein.

Moreover, once the hot air has been released, there is not currently a clean and effective method for removing the hot fluids contained in the bag. The conventional method for removing the fluids contained within the bag is to release them through the closure in which the food was inserted. However, this method frequently results in spillage of the fluids which can cause burns and make a mess. Therefore, a need exists for an improved apparatus and method for removing hot fluids from a roasting bag.

Furthermore, in the case of more bulky food items like a large turkey, the shear mass of the food item can cause additional complications in positioning the roasting bag and food item over a container to capture the fluids as they exit the bag. Therefore a need exists for an improved method of handling a roasting bag that will allow the roasting bag to be easily positioned over a container.

### SUMMARY OF THE INVENTION

The present invention is an improved roasting bag for food items. The improved roasting bag contains a valve to drain fluids out of the bag. The improved roasting bag also contains a pair of handles which are used to orient and position the improved roasting bag while the fluids are draining out of the improved roasting bag. The invention also contains a vent slit to help facilitate the draining process. A number of different valve configurations are disclosed to use in conjunction with the present invention.

### BRIEF DESCRIPTION OF THE DRAWINGS

FIG. 1 is an illustration of the improved roasting bag.

FIG. 2 is an illustration of a turkey inserted into the improved roasting bag.

FIG. 3 is an illustration of the process of draining the fluids from the improved roasting bag.

FIG. 4 is an illustration of a screw on cap which may be implemented on the improved roasting bag.

FIG. 5 is an illustration of a push type valve which may be implemented on the improved roasting bag.

FIG. 6 is an illustration of a pull-type valve which may be implemented on the improved roasting bag.

FIG. 7 is an illustration of a twist-type valve which may be implemented on the improved roasting bag.

### DETAILED DESCRIPTION OF THE PREFERRED EMBODIMENT

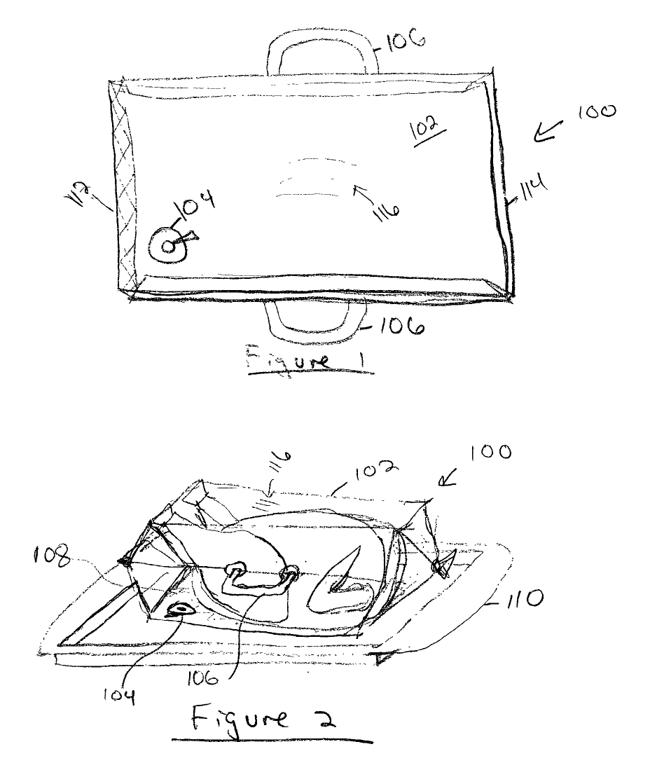

FIG. 1 is an illustration of improved roasting bag 100. Improved roasting bag 100 is comprised of bag 102, valve 104, and handles 106. Improved roasting bag 100 may be constructed out of plastic, aluminum, or any other material suitable for construction of baking bags as determined by those skilled in the art. Improved roasting bag 100 should be constructed of a material sturdy enough to support the weight of the food items when improved roasting bag 100 is supported by handles 106.

Improved roasting bag 100 has sealed end 112 and open end 114. Sealed end 112 is sufficiently sealed such that any food items, fluids, or gasses in improved roasting bag 100 cannot escape through sealed end 112. Food items and/or basting juices are placed into improved roasting bag 100 through open end 114. Improved roasting bag 100 is sufficiently large such that when the food items and/or basting juices are placed inside improved roasting bag 100, open end 114 can still be closed with a twist tie (not shown). Alternatively, open end 114 can be sealed with a freezer or sandwich bag style closure (i.e. a ZIPLOC® style closure). Those skilled in the art will also be aware of other methods of sealing open end 114. When open end 114 is closed, improved roasting bag 100 will be sufficiently sealed such that the food items, the basting fluids, any other fluids, or any gasses will not be able to escape improved roasting bag 100. In the preferred embodiment, improved roasting bag 100 has one sealed end 112 and one open end 114. In alternative embodiments, improved roasting bag 100 may have two open ends 114. This embodiment facilitates easy handling of the food items prior to open ends 114.

Improved roasting bag 100 also contains valve 104. Valve 104 can be used to facilitate the release of gasses, liquids or both from improved roasting bag 100. For release of gasses, improved roasting bag 100 is oriented with valve 104 in a position where it is not in contact with any fluids contained within improved roasting bag 100. In this position, the act of opening valve 104 will release the hot gasses contained within improved roasting bag 100 and not release any of the fluids contained within improved roasting bag 100. For release of fluids, improved roasting bag 100 is oriented with valve 104 in a position where it is in contact with the fluids contained within improved roasting bag 100. In this position, the act of opening valve 104 will release the fluids contained within improved roasting bag 100. Alternatively, valve 104 may be opened when it is not in contact with the fluids and then improved roasting bag 100 may be oriented such that the fluids will drain out of open valve 104. Improved roasting bag 100 may contain more than one valve 104 such that one valve can be used to release gasses and another used to release fluids. Furthermore, valve 104 may be located on any side of improved roasting bag 100.

Improved roasting bag 100 also contains two handles 106. Handles 106 are used to move and orient improved roasting bag 100. Handles 106 are particularly useful when the orientation of improved roasting bag 100 needs to be changed to promote the draining of fluids from improved roasting bag 100. Handles 106 are preferably attached to the sides of improved roasting bag 100, but may alternatively be attached to the top and bottom of improved roasting bag 100. A person skilled in the art will know how to attach handles 106 to improved roasting bag 100 such that handles 106 will support the weight of improved roasting bag 100 and any food items and fluids contained therein. A person skilled in the art will also know the best location to attach handles 106 to improved roasting bag 100 such that fluids will easily drain out of improved roasting bag 100 via valve 104.

Improved roasting bag may also contain optional vents 116. Vents 116 are normally covered with a piece of tape or similar closure during the baking process. The tape or similar closure may be removed to expose vents 116 to allow the release of hot gasses from improved roasting bag 100. Alternatively, vents 116 may be exposed in order to vent roasting bag 100 and achieve more efficient draining of fluids from improved roasting bag 100 via valve 104.

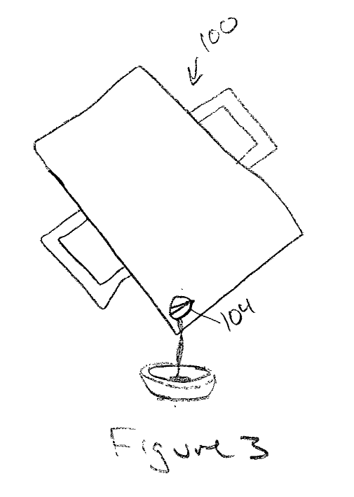

FIG. 2 is an illustration of a food item, specifically a turkey, inserted into improved roasting bag 100. Under normal baking circumstances, the food item will be placed inside improved roasting bag 100 and improved roasting bag 100 is sealed. Improved roasting bag 100 is then placed on baking tray 110 and inserted into an oven. During the baking process, fluids 108 may accumulate in the bottom of improved roasting bag 100. Alternatively, fluids 108 may be basting fluids that were inserted into improved roasting bag 100 along the food items. When the baking process is finished, the fluids 108 may be drained out of improved roasting bag 100 via valve 104, as illustrated in FIG. 3.

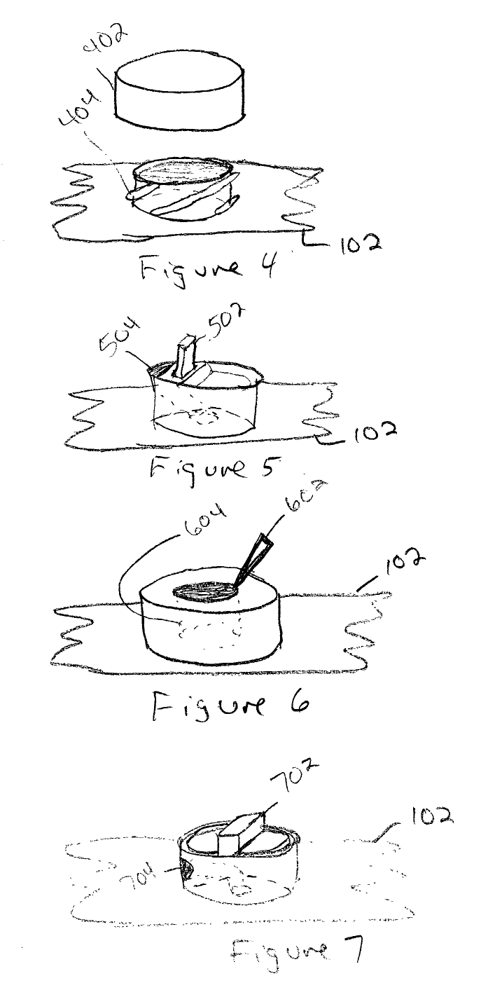

There are many different configurations of valve 104 that can be used in improved roasting bag 100. FIG. 4 is an illustration of a screw on cap type valve which may be implemented on improved roasting bag 100. Here, the valve consists of cap 402 which screws onto threads 404 on the lower half of the valve assembly. Optional plug (not shown) may be inserted into the lower half of the valve assembly in order to further seal the valve when cap 402 is screwed onto threads 404. Threads 404 and the lower half of the valve assembly are permanently affixed to bag 102.

FIG. 5 is an illustration of a push type valve which may be implemented on improved roasting bag 100. Push type valves can normally be found on disposable fluid containers like wine boxes. In a push type valve assembly, the valve is normally closed. However, when release 502 is pushed in the direction away from cavity 504, the valve opens and the fluids inside bag 102 can drain out via cavity 504.

FIG. 6 is an illustration of a pull type valve which may be implemented on improved roasting bag 100. Pull type valve is a single use valve that is normally sealed. When pull tab 602 is pulled away from the valve body, cavity 604 is exposed. Fluids may then drain out of bag 102 through cavity 604. Pull type valves are commonly used on cans of liquids such as soda cans.

FIG. 7 is an illustration of a twist type valve which may be implemented on improved roasting bag 100. In a twist type valve, a channel exists inside the body of the valve that normally ends at the sidewall of valve body. To open the valve, handle 702 is turned so that cavity 704 is exposed to the inside of bag 102 through a channel in the valve body (indicated by the dotted line in FIG. 7). When this occurs, fluids may drain out of bag 102 through the valve channel and cavity 704.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Additionally, the steps of the present invention need not be implemented in the order disclosed herein. The novel spirit of the present invention is still embodied by reordering or deleting some of the steps contained in this disclosure. The spirit of the invention is not meant to be limited in any way except by proper construction of the following claims.

What is claimed is:

1. An apparatus for cooking food items comprising:
a roasting bag;
a valve affixed to said roasting bag;
wherein said roasting bag captures a fluid during a roasting process; and
wherein said fluids contained in said roasting bag can be removed from said roasting bag through said valve.

2. The apparatus of claim 1 further comprising at least one handle used for positioning said roasting bag during said fluid removal process.

3. The apparatus of claim 1 further comprising at least one vent.

4. The apparatus of claim 1 further comprising a sealed end and a closed end.

5. The apparatus of claim 1 wherein a basting fluid is placed into said roasting bag prior to said roasting process.

6. The apparatus of claim 1 wherein said valve is a screw on cap type valve.

7. The apparatus of claim 1 wherein said valve is a push type valve.

8. The apparatus of claim 1 wherein said valve is a pull type valve.

9. The apparatus of claim 1 wherein said valve is a twist type valve.

10. An apparatus for cooking food items in an cooking device comprising:
a roasting bag;
at least one handle affixed to said roasting bag;
wherein said bag captures a fluid during a roasting process; and
wherein said handle is used for positioning said roasting bag after said roasting process.

11. The apparatus of claim 10 further comprising a valve affixed to said roasting bag.

12. The apparatus of claim 11 wherein said fluids contained in said roasting bag can be removed from said bag through said valve.

13. The apparatus of claim 10 further comprising at least one vent.

14. The apparatus of claim 10 further comprising a sealed end and a closed end.

15. The apparatus of claim 10 wherein a basting fluid is placed into said roasting bag prior to said roasting process.

16. The apparatus of claim 11 wherein said valve is a screw on cap type valve.

17. The apparatus of claim 11 wherein said valve is a push type valve.

18. The apparatus of claim 11 wherein said valve is a pull type valve.

19. The apparatus of claim 11 wherein said valve is a twist type valve.

20. A method of producing a fluid from a roasting bag comprising:
placing a food item inside a roasting bag;
placing a basting fluid inside said roasting bag;
sealing said roasting bag;
placing said roasting bag containing said food items inside a cooking device;
cooking said food items;
removing said roasting bag and said food items from said cooking device;
positioning said roasting bag over a container; and
opening a valve to remove a fluid from said roasting bag.

21. The method of claim 20 further comprising the step of venting said roasting bag.

22. The method of claim 20 wherein a handle is used to position said roasting bag.

23. The method of claim 20 wherein said fluid is used to make a gravy.

24. The method of claim 20 wherein said valve is a screw on cap type valve.

25. The method of claim 20 wherein said valve is a push type valve.

26. The method of claim 20 wherein said valve is a pull type valve.

27. The method of claim 20 wherein said valve is a twist type valve.
